(19) United States
(12) Patent Application Publication
(10) Pub. No.: US 2023/0315033 A1
(43) Pub. Date: Oct. 5, 2023

(54) Method and Apparatus for Controlling a Device

(71) Applicant: Telefonaktiebolaget LM Ericsson (publ), Stockholm (SE)

(72) Inventor: Ning Zhang, Beijing (CN)

(21) Appl. No.: 18/023,414

(22) PCT Filed: Aug. 28, 2020
(86) PCT No.: PCT/CN2020/112168

§ 371 Date: Feb. 27, 2023

(51) Int. Cl. G05B 15/02

(52) U.S. Cl. CPC G05B 15/02

(57) ABSTRACT

Embodiments of the present disclosure provide methods and apparatuses for controlling a device. A method performed by a controller comprises determining a scenario related to at least one user. The method further comprises sending a message for controlling at least one device to run in a mode dedicated for the determined scenario to the at least one device.

### TECHNICAL FIELD

The non-limiting and exemplary embodiments of the present disclosure generally relate to the technical field of communications, and specifically to methods and apparatuses for controlling a device.

### BACKGROUND

This section introduces aspects that may facilitate a better understanding of the disclosure. Accordingly, the statements of this section are to be read in this light and are not to be understood as admissions about what is in the prior art or what is not in the prior art.

A device such as a smart device or an intelligent device may be connected to other devices or networks via different wireless or wired communication techniques such as Bluetooth, Zigbee, NFC (near-field communication), Wi-Fi, etc. A smart device may be a smart household appliance, a smartphone, a smart car, a smart thermostat, a smart doorbell, a smart lock, a smart refrigerator, a smart watch, a smart band, a smart key chain, a smart speaker, etc.

Currently, there are many household appliances equipped with IoT (Internet of Things) devices which may enable the household appliances to become a part of Internet. For example, the household appliances may be a smart TV (television), an audio equipment, a microwave oven, a curtain, etc. The household appliances may help some people in their respective domains, for example, the people who are too busy to do housework or spend time to select a favorite TV program for entertainment. Moreover, elder people may enjoy a benefit of the household appliances since they may not have experience to operate hi-tech devices via a keypad, a remote control or a touchpad which may require a lot of background technical knowledge. The elder people may need to speak out an instruction to a household appliance, or their children can help them to make a good pre-definition and pre-settings according to their preference.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

There may be some problems regarding how to control a device such as a smart device. A problem may be that a device such as a smart device cannot bring much more intelligence to a user. For example, even though smart devices such as smart household appliances are intelligent, they may work in their restricted and separated domains, which means they seldom exchange and utilize information to work together, and cannot bring much more intelligence to a user.

Another problem may be that each user may have to manually adjust settings of a smart device, which is shared by more than one user. For example, different users may have various interests/preferences and it is hard to adjust settings of a smart device to satisfy interests/preferences of the different users. So each user may have to manually change the settings of the smart device. For example, in a common space such as an apartment or a house, there may be two or more persons who are living together or work together. Each person may have his/her own style or preference to use a smart device, e.g. a smart TV, but there is no solution to distinguish different persons and control the smart device to automatically work according to each person's preference or interest. Therefore each person may have to manually adjust the settings of the smart device every time when he/she uses the smart device, which is not intelligent.

Another problem may be that it may cost much time to set a proper access right for each user. For example, different users may have different access rights to a smart device. For example, a teenage should not watch a TV program that is dedicated for adults, a child should not expend money online that exceeds a certain amount, and a babysitter should not know a financial status of a family served by the babysitter. It may cost much time to set a proper access right individually, and the individual access rights need to be maintained for the future.

Another problem may be that some operation of a smart device may be inconvenient for some special persons. For example, a smart device may be operated by a voice or a gesture. However, it is inconvenient for some people like a deaf and/or dumb, or elder people.

Another problem may be that some activities may be performed far away from a smart device. For example, some family activities, such as gardening, may be far away from a smart device inside a house. The people who like these activities may also expect an assistant of the smart device.

To overcome or mitigate at least one of the above mentioned problems or other problems, embodiments of the present disclosure propose an improved solution for controlling a device.

In a first aspect of the disclosure, there is provided a method performed by a controller. The method comprises determining a scenario related to at least one user. The method further comprises sending a message for controlling at least one device to run in a mode dedicated for the determined scenario to the at least one device.

In an embodiment, the method may further comprise determining the user preference for the at least one device.

In an embodiment, the method may further comprise determining the user access right for the at least one device.

In an embodiment, the method may further comprise providing a mode list to the at least one user based on the determined scenario.

In an embodiment, the method may further comprise receiving information of a mode selected by the at least one user.

In an embodiment, the method may further comprise providing information regarding at least one suggested activity to the at least one user based on the determined scenario.

In an embodiment, the method may further comprise receiving a feedback regarding whether the at least one suggested activity is appropriate from the at least one user.

In an embodiment, the method may further comprise collecting data regarding the at least one device.

In an embodiment, the method may further comprise collecting data regarding the at least one user.

In an embodiment, the method may further comprise receiving information of at least one food material in a cabinet of a microwave oven from the microwave oven.

In an embodiment, the method may further comprise checking whether the at least one food material fits a space for cooking.

In an embodiment, the method may further comprise, when the at least one food material does not fit the space for cooking, providing a prompting message to the at least one user.

In an embodiment, the method may further comprise determining nutrition information of at least one food material in a cabinet of a microwave oven.

In an embodiment, the method may further comprise providing the nutrition information of the at least one food material to the at least one user.

In an embodiment, determining a scenario related to at least one user may comprise receiving tracking information regarding a twin; and recognizing the twin based on the tracking information.

In an embodiment, the method may further providing recognition information of the twin to a user.

In an embodiment, the controller may be implemented in a server or the at least one device.

In an embodiment, the scenario related to at least one user may comprise any information of an identity of the at least one user; a number of the at least one user; an activity of the at least one user; conversation content of the at least one user; a physical state of the at least one user; a psychological state of the at least one user; environmental data related to the at least one user; a habit of the at least one user; an interest of the at least one user; a schedule of the at least one user; an emotion of the at least one user; or an expression of the at least one user.

In an embodiment, the environmental data related to the at least one user may comprise at least one of climate data; weather data; time data; location data; traffic condition data; or passenger flow data.

In an embodiment, the mode dedicated for the determined scenario may comprise at least one of a mode dedicated for a user preference for the device; a mode dedicated for a user access right for the device; or a mode selected by the at least one user.

In an embodiment, when there are two or more users in the determined scenario, the device may be controlled to run in a mode dedicated for a lowest user access right of the two or more users.

In an embodiment, controlling the device to run in the mode dedicated for the determined scenario may comprise at least one of controlling a television set to list at least one program that is useful to the at least one user; controlling a device to provide a summary list of the at least one program to the at least one user; controlling a display of a vehicle to display the at least one program; controlling a device to record a video for the at least one user; controlling a device to hide at least one message related to the video; controlling a device to provide a reminder of backup to the at least one user; controlling a device to provide a recommended shopping list to the at least one user; or controlling a device to provide availability information of at least one nearby laundry room to the at least one user.

In a second aspect of the disclosure, there is provided a method performed by a device. The method comprises receiving a message for controlling the device to run in a mode dedicated for a specific scenario related to at least one user from a controller. The method further comprises running in the mode dedicated for the specific scenario.

In an embodiment, the specific scenario may comprise any information of an identity of the at least one user; a number of the at least one user; an activity of the at least one user; conversation content of the at least one user; a physical state of the at least one user; a psychological state of the at least one user; environmental data related to the at least one user; a habit of the at least one user; an interest of the at least one user; a schedule of the at least one user; an emotion of the at least one user; or an expression of the at least one user.

In an embodiment, the mode dedicated for the specific scenario may comprise at least one of: a mode dedicated for a user preference for the device; a mode dedicated for a user access right for the device; or a mode selected by the at least one user.

In an embodiment, when there are two or more users in the specific scenario, the device is controlled to run in a mode dedicated for a lowest user access right of the two or more users.

In an embodiment, controlling the device to run in the mode dedicated for the specific scenario may comprise at least one of controlling a television set to list at least one program that is useful to the at least one user; controlling a device to provide a summary list of the at least one program to the at least one user; controlling a display of a vehicle to display the at least one program; controlling a device to record a video for the at least one user; controlling a device to hide at least one message related to the video; controlling a device to provide a reminder of backup to the at least one user; controlling a device to provide a recommended shopping list to the at least one user; or controlling a device to provide availability information of at least one nearby laundry room to the at least one user.

In an embodiment, the method may further comprise receiving a mode list from the controller.

In an embodiment, the method may further comprise providing the mode list to the at least one user.

In an embodiment, the method may further comprise receiving information of a mode selected by the at least one user.

In an embodiment, the method may further comprise sending the information of the mode selected by the at least one user to the controller.

In an embodiment, the method may further comprise receiving information regarding at least one suggested activity from the controller.

In an embodiment, the method may further comprise providing the information regarding at least one suggested activity to the at least one user.

In an embodiment, the method may further comprise receiving a feedback regarding whether the at least one suggested activity is appropriate from the at least one user.

In an embodiment, the method may further comprise sending the feedback to the controller.

In an embodiment, the method may further comprise sending data regarding the device to the controller.

In an embodiment, the method may further comprise sending data regarding the at least one user to the controller.

In an embodiment, the data regarding the device may comprise settings and/or status information of the device.

In an embodiment, the data regarding the at least one user may comprise the at least one of an activity of the at least one user; conversation content of the at least one user; a physical state of the at least one user; a psychological state of the at least one user; environmental data related to the at least one user; a habit of the at least one user; an interest of the at least one user; a schedule of the at least one user; an emotion of the at least one user; or an expression of the at least one user.

In an embodiment, the at least one user may comprise at least one of a family member, a visitor, a babysitter, a stranger, a colleague, a friend, a neighbor, a passenger, a worker, or a driver.

In an embodiment, the device may comprise at least one of a household appliance; a car appliance; a municipal infrastructure; an industrial electrical equipment; a computer; a mobile phone; or an office appliance.

In an embodiment, the method may further comprise sending information of at least one food material in a cabinet of a microwave oven to the controller.

In an embodiment, the method may further comprise receiving a prompting message indicating that the at least one food material does not fit the space for cooking.

In an embodiment, the method may further comprise providing the prompting message to the at least one user.

In an embodiment, the method may further comprise receiving nutrition information of at least one food material. In an embodiment, the method may further comprise providing the nutrition information of the at least one food material to the at least one user.

In an embodiment, the method may further comprise obtaining tracking information regarding a twin. In an embodiment, the method may further comprise sending the tracking information of the twin to the controller.

In an embodiment, the method may further comprise receiving recognition information of the twin from the controller. The method may further comprise providing the recognition information of the twin to a user.

In a third aspect of the disclosure, there is provided a controller. The controller comprises a processor; and a memory coupled to the processor, said memory containing instructions executable by said processor, whereby said controller is operative to determine a scenario related to at least one user. Said controller is further operative to send a message for controlling at least one device to run in a mode dedicated for the determined scenario to the at least one device.

In a fourth aspect of the disclosure, there is provided a device. The device comprises a processor; and a memory coupled to the processor, said memory containing instructions executable by said processor, whereby said device is operative to receive a message for controlling the device to run in a mode dedicated for a specific scenario related to at least one user from a controller. Said device is further operative to run in the mode dedicated for the specific scenario.

In a fifth aspect of the disclosure, there is provided a controller. The controller comprises a first determining module and a sending module. The determining module may be configured to determine a scenario related to at least one user. The sending module may be configured to send a message for controlling at least one device to run in a mode dedicated for the determined scenario to the at least one device.

In an embodiment, the controller may further comprise a second determining module configured to determine the user preference for the at least one device.

In an embodiment, the controller may further comprise a third determining module configured to determine the user access right for the at least one device.

In an embodiment, the controller may further comprise a first providing module configured to provide a mode list to the at least one user based on the determined scenario.

In an embodiment, the controller may further comprise a first receiving module configured to receive information of a mode selected by the at least one user.

In an embodiment, the controller may further comprise a second providing module configured to provide information regarding at least one suggested activity to the at least one user based on the determined scenario.

In an embodiment, the controller may further comprise a second receiving module configured to receive a feedback regarding whether the at least one suggested activity is appropriate from the at least one user.

In an embodiment, the controller may further comprise a first collecting module configured to collect data regarding the at least one device.

In an embodiment, the controller may further comprise a second collecting module configured to collect data regarding the at least one user.

In an embodiment, the controller may further comprise a third receiving module configured to receive information of at least one food material in a cabinet of a microwave oven from the microwave oven.

In an embodiment, the controller may further comprise a checking module configured to check whether the at least one food material fits a space for cooking.

In an embodiment, the controller may further comprise a third providing module configured to, when the at least one food material does not fit the space for cooking, provide a prompting message to the at least one user.

In an embodiment, the controller may further comprise a fourth determining module configured to determine nutrition information of at least one food material in a cabinet of a microwave oven.

In an embodiment, the controller may further comprise a fourth providing module configured to provide the nutrition information of the at least one food material to the at least one user.

In an embodiment, the controller may further comprise a fourth receiving module configured to receive tracking information regarding a twin.

In an embodiment, the controller may further comprise a recognizing module configured to recognize the twin based on the tracking information.

In an embodiment, the controller may further comprise a first providing module configured to providing recognition information of the twin to a user.

In a sixth aspect of the disclosure, there is provided a device. The device comprises a first receiving module and a running module. The first receiving module may be configured to receive a message for controlling the device to run in a mode dedicated for a specific scenario related to at least one user from a controller. The running module may be configured to run in the mode dedicated for the specific scenario.

In an embodiment, the device may further comprise a second receiving module configured to receive a mode list from the controller. The device may further comprise a first providing module configured to provide the mode list to the at least one user. The device may further comprise a third receiving module configured to receive information of a mode selected by the at least one user. The device may further comprise a first sending module configured to send the information of the mode selected by the at least one user to the controller.

In an embodiment, the device may further comprise a fourth receiving module configured to receive information regarding at least one suggested activity from the controller. The device may further comprise a second providing module configured to provide the information regarding at least one suggested activity to the at least one user.

In an embodiment, the device may further comprise a fifth receiving module configured to receive a feedback regarding whether the at least one suggested activity is appropriate from the at least one user. The device may further comprise a second sending module configured to send the feedback to the controller.

In an embodiment, the device may further comprise a third sending module configured to send data regarding the device to the controller. The device may further comprise a fourth sending module configured to send data regarding the at least one user to the controller.

In an embodiment, the device may further comprise a fifth sending module configured to send information of at least one food material in a cabinet of a microwave oven to the controller. The device may further comprise a sixth receiving module configured to receive a prompting message indicating that the at least one food material does not fit the space for cooking. The device may further comprise a third providing module configured to provide the prompting message to the at least one user.

In an embodiment, the device may further comprise a seventh receiving module configured to receive nutrition information of at least one food material. The device may further comprise a fourth providing module configured to provide the nutrition information of the at least one food material to the at least one user.

In an embodiment, the device may further comprise an obtaining module configured to obtain tracking information regarding a twin. The device may further comprise a sixth sending module configured to send the tracking information of the twin to the controller.

In an embodiment, the device may further comprise an eighth receiving module configured to receive recognition information of the twin from the controller. The device may further comprise a fifth providing module configured to provide the recognition information of the twin to a user.

According to a seventh aspect of the disclosure it is provided a computer program product comprising instructions which when executed by at least one processor, cause the at least one processor to perform any of the methods according to the first and second aspects of the disclosure.

According to an eighth aspect of the disclosure it is provided computer-readable storage medium storing instructions which when executed by at least one processor, cause the at least one processor to perform any of the methods according to the first and second aspects of the disclosure.

Various embodiments herein offer various advantages, of which a non-exhaustive list of examples follows. In some embodiments herein, the proposed solution may enable a controller to control at least one device to run in a mode dedicated for a specific scenario. In some embodiments herein, the proposed solution may bring a good user experience to a user. In some embodiments herein, the proposed solution may enable two or more devices to cooperate together so that a user may enjoy convenience. In some embodiments herein, the proposed solution may protect private information. The embodiments herein are not limited to the features and advantages mentioned above. A person skilled in the art will recognize additional features and advantages upon reading the detailed description.

### BRIEF DESCRIPTION OF THE DRAWINGS

The above and other aspects, features, and benefits of various embodiments of the present disclosure will become more apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 is a diagram illustrating an exemplary system into which an embodiment of the disclosure is applicable;

FIG. 2 shows a flowchart of a method according to an embodiment of the present disclosure;

FIG. 3 shows a flowchart of a method according to another embodiment of the present disclosure;

FIG. 4 shows a flowchart of a method according to another embodiment of the present disclosure;

FIG. 5 shows a flowchart of a method according to another embodiment of the present disclosure;

FIG. 6 shows a flowchart of a method according to another embodiment of the present disclosure;

FIG. 7 shows a flowchart of a method according to another embodiment of the present disclosure;

FIG. 8 shows a flowchart of a method according to another embodiment of the present disclosure;

FIG. 9 shows a flowchart of a method according to another embodiment of the present disclosure;

FIG. 10 shows a flowchart of a method according to another embodiment of the present disclosure;

FIG. 11 shows a flowchart of a method according to another embodiment of the present disclosure;

FIG. 12 shows a flowchart of a method according to another embodiment of the present disclosure;

FIG. 13 shows a flowchart of a method according to another embodiment of the present disclosure;

FIG. 14 shows a flowchart of a method according to another embodiment of the present disclosure;

FIG. 15 shows a flowchart of a method according to another embodiment of the present disclosure;

FIG. 16 shows an example of TV program selection according to an embodiment of the present disclosure;

FIG. 17 shows an example of microwave oven cooking program setting according to an embodiment of the present disclosure;

FIG. 18 shows an example of air conditioner temperature settings, purifier settings and humidifier settings according to an embodiment of the present disclosure;

FIG. 19 shows an example of twin children babysitting according to an embodiment of the present disclosure;

FIG. 20 shows an example of businessman assistant after back home according to an embodiment of the present disclosure;

FIG. 21 is a block diagram showing an apparatus suitable for practicing some embodiments of the disclosure;

FIG. 22 is a block diagram showing a controller according to an embodiment of the disclosure; and

FIG. 23 is a block diagram showing a device according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

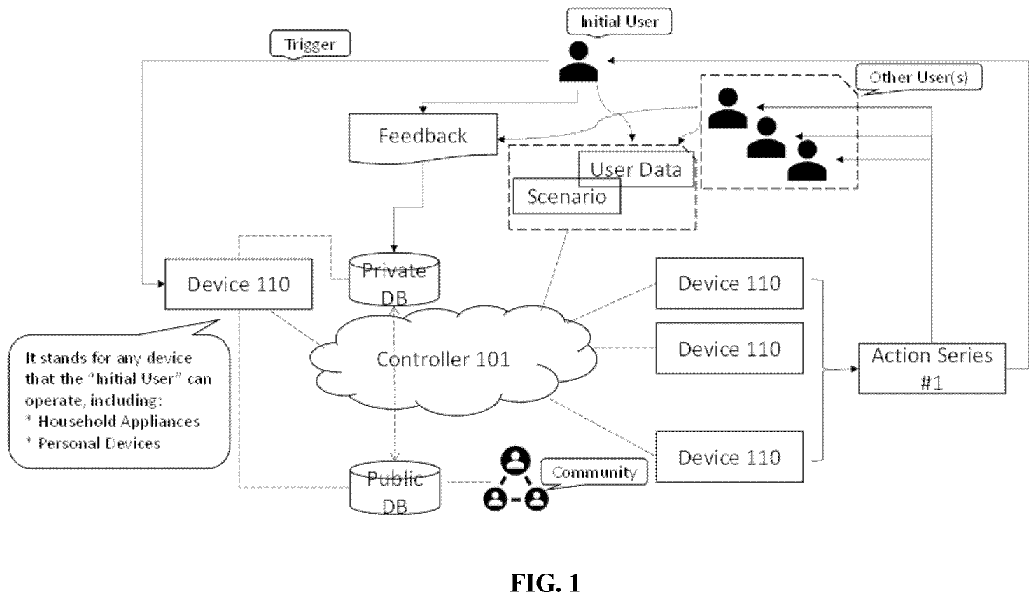

FIG. 1 is a diagram illustrating an exemplary system into which an embodiment of the disclosure is applicable. As shown, the system may comprise a controller 101 and at least one device 110. The controller 101 may be any suitable device that supports controlling function. For example, the controller 101 may include, but not limited to, a portable computer, a gaming terminal device, a music storage and playback appliance, a mobile phone, a cellular phone, a smart phone, a tablet, a wearable device, a personal digital assistant (PDA), a portable computer, a desktop computer, a wearable terminal device, a vehicle-mounted wireless terminal device, a wireless endpoint, a mobile station, a server, a household appliance, a car appliance, a municipal infrastructure; an industrial electrical equipment, an office appliance, etc. The at least one device 110 may be any suitable device that can be used by a user or can serve the user. For example, the at least one device 110 may include, but not limited to, a portable computer, a gaming terminal device, a music storage and playback appliance, a mobile phone, a cellular phone, a smart phone, a tablet, a wearable device, a personal digital assistant (PDA), a portable computer, a desktop computer, a wearable terminal device, a vehicle-mounted wireless terminal device, a wireless endpoint, a mobile station, a server, a household appliance, a car appliance, a municipal infrastructure; an industrial electrical equipment, an office appliance, etc.

The at least one device 110 may be communicated with the controller 101 by a network such as any suitable wireless or wired communication network. Furthermore, the network may include, but not limited to, a communication network as defined by a standard organization such as third Generation Partnership Project (3GPP) (such as the first generation (1G), 2G, 3G, 4G, 4.5G, 5G communication networks), and/or any other communication networks either currently known or to be developed in the future.

There may be at least one database (DB) that stores data such as user data and device data. In an embodiment, the at least one DB may have two categories. For example, one DB (e.g., a public DB) may store the data regarding the device such as household appliance and another DB (e.g., a private DB) may store data regarding a user such as a family member.

The controller 101 may deliver at least one suggested activity to a user based on the data collected and stored in the at least one DB. For example, the data may include a user's current space, an activity of a user, a user's physical status, any other suitable information related to a user.

The controller 101 may deliver a suggested action or running mode to at least one device based on the data collected and stored in the at least one DB.

A user can feed back whether at least one suggested activity and/or at least one suggested action or running mode is appropriate.

The controller 101 may be a standalone device or can be implemented in any suitable device. For example, the controller 101 may be implemented in a private device, e.g. a home server, a personal computer, etc. The controller 101 may be implemented in a public server (such as a cloud server, etc.). The controller 101 may be partly implemented in a public server and partly implemented in a public server. A specific implementation of the controller may depend on various requirements such as privacy requirements. The controller 101 can be upgraded automatically for any specified scenario based on AI/ML (artificial intelligence/machine learning) algorithm by referring at least one other similar scenarios which have been proved to be useful to users.

The controller 101 can control the at least one device 110. The at least one device 110 may be the same or different devices. Though only one controller 101 is shown in FIG. 1, there may be two or more controllers 101 in other embodiments. For example, a first controller may control a part of the devices 110, a second controller may control another part of the devices 110, and so on.

Though the controller 101 is shown as an independent equipment in FIG. 1, it can be integrated into other suitable devices. For example, the controller 101 may be integrated into any one of the device 110.

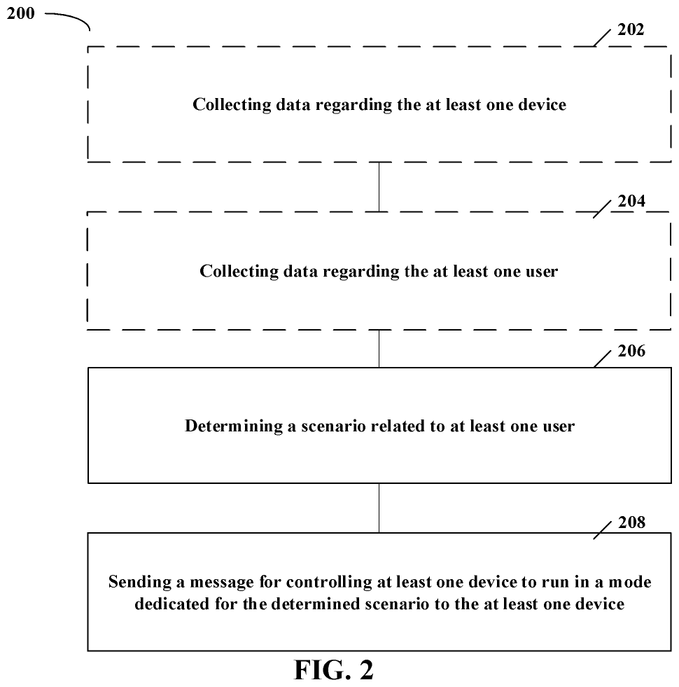

FIG. 2 shows a flowchart of a method 200 according to an embodiment of the present disclosure, which may be performed by an apparatus implemented in or as or communicatively coupled to a controller or any other entity having similar functionality. As such, the apparatus may provide means or modules for performing various operations of the method 200 as well as means or modules for performing other operations in conjunction with other components.

In an embodiment, the controller may be implemented in a server (e.g. a personal server or a public server such as a cloud server) or a terminal device (e.g. a household appliance, a mobile phone).

At block 202, optionally, the controller may collect data regarding at least one device. The at least one device may be any suitable device such as smart device which can be controlled by the controller. The data regarding at least one device may comprise any suitable data related to the at least one device, such as location information, performance parameters, settings and/or status information, and environmental data (such as climate, weather, indoor environmental data, etc.) related to the at least one device.

In an embodiment, the environmental data related to the at least one device may comprise any of climate data; weather data; time data; location data; traffic condition data; or passenger flow data.

The controller may collect the data regarding at least one device in various ways. For example, the controller can collect the data regarding at least one device from the at least one device or any other suitable device such as another controller. The data regarding at least one device may be input into the controller by a user.

In an embodiment, the data regarding the at least one device may comprise settings and/or status information of the at least one device. For example, the data regarding the at least one device may be a playlist of an audio device, a program list of a TV set, an air conditioner settings, storage contents in an refrigerator, a refrigerator settings, a microwave oven settings, curtain status, an air temperature, an air humidity, a shower temperature, etc.

In an embodiment, the data regarding the at least one device may further comprise a timestamp indicating a collecting time of the data regarding the at least one device.

In an embodiment, the data regarding the at least one device may further comprise user information indicating which user(s) is currently using the at least one device.

In an embodiment, the at least one device may comprise at least one of a household appliance; a car appliance; a municipal infrastructure; an industrial electrical equipment; a computer; a mobile phone; or an office appliance.

At block 204, optionally, the controller may collect data regarding at least one user. The data regarding at least one user may comprise any suitable data related to the at least one user, such as location information of the at least one user, conversation among at least one user (such as family members), an abstract of the conversation, an activity of the at least one user (such as a kinetic game, a housekeeping task, a cooking task, a gardening task or a babysitting task, etc.), physical status of the at least one user (such as face, hair, body shape, etc.), the at least one user's habit, interests and schedules, etc. The controller may collect the data regarding the at least one user in various ways. For example, the controller may collect the data regarding the at least one user from the at least one device or other device. The data regarding the at least one user may be input into the controller by a user. The data regarding the at least one user may be learned by the controller. The data regarding the at least one user may collected by the controller from another controller.

In an embodiment, the data regarding the at least one user may comprise any of: an activity of the at least one user; conversation content of the at least one user; a physical state of the at least one user; a psychological state of the at least one user; environmental data related to the at least one user; a habit of the at least one user; an interest of the at least one user; a schedule of the at least one user; an emotion of the at least one user; or an expression of the at least one user.

In an embodiment, the environmental data related to the at least one user may comprise any of climate data; weather data; time data; location data; traffic condition data; or passenger flow data.

In an embodiment, the data regarding the at least one user may further comprise a timestamp indicating a collecting time of the data regarding the at least one user.

The at least one user may be any suitable user which can use the at least one device and/or be served by the at least one device. In an embodiment, the at least one user may comprise any of: a family member, a visitor, a babysitter, a stranger, a colleague, a friend, a neighbor, a passenger, a worker, or a driver.

At block 206, the controller may determine a scenario related to the at least one user. The scenario related to the at least one user may be any suitable scenario.

The controller may determine the scenario related to the at least one user in various ways. For example, the controller may determine the scenario related to the at least one user by using the data collected at blocks 202 and 204. The scenario related to at least one user may be input into the controller by the at least one user. The controller may determine the scenario related to the at least one user by receiving information regarding the scenario related to the at least one user from another controller.

In an embodiment, the scenario related to at least one user may be determined based on at least one information of: an identity of the at least one user; a number of the at least one user; an activity of the at least one user; conversation content of the at least one user; a physical state of the at least one user; a psychological state of the at least one user; environmental data related to the at least one user; a habit of the at least one user; an interest of the at least one user; a schedule of the at least one user; an emotion of the at least one user; or an expression of the at least one user.

In an embodiment, the scenario related to at least one user may comprise any information of: an identity of the at least one user; a number of the at least one user; an activity of the at least one user; conversation content of the at least one user; a physical state of the at least one user; a psychological state of the at least one user; environmental data related to the at least one user; a habit of the at least one user; an interest of the at least one user; a schedule of the at least one user; an emotion of the at least one user; or an expression of the at least one user.

For example, the controller may determine that which user(s) is currently using or to use the at least one device. The controller may determine a specific activity (such as a housekeeping task) performed by he at least one user. The controller may determine the conversation content (for example, the conversation is relevant to IoT (Internet of Thing) and its derivative areas) of the at least one user. The controller may determine that the at least one user falls ill. The controller may determine that the at least one user is happy. The controller may determine that the weather is cold. The controller may determine that the at least one user always sets a temperature of an air condition as 26 degrees in centigrade. The controller may determine that the at least one user likes to watch a move on weekends. The controller may determine that the at least one user is about to go shopping at 10:30 AM. The controller may determine that the at least one user is showing anxiety.

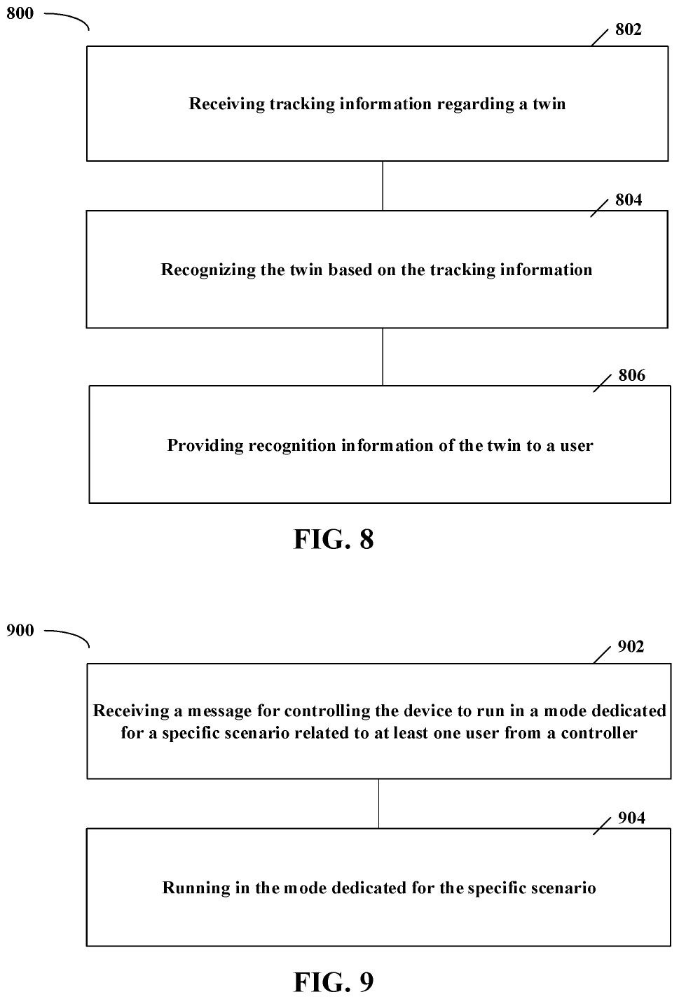

In an embodiment, determining a scenario related to at least one user may comprise receiving tracking information regarding a twin and recognizing the twin based on the tracking information, which will be described in FIG. 8.

At block 208, the controller may send a message for controlling at least one device to run in a mode dedicated for the determined scenario to the at least one device. The mode dedicated for the determined scenario may be a mode that has been previously stored in the controller, or a mode that has learned by the controller for example using machine learning, or a mode that has been input into the controller by the at least one user, or a mode that has been rectified by the controller for example based on a feedback of the at least one user.

In an embodiment, the mode dedicated for the determined scenario may comprise at least one of a mode dedicated for a user preference for the at least one device; a mode dedicated for a user access right for the at least one device; or a mode selected by the at least one user.

In an embodiment, when there are two or more users in the determined scenario, the at least one device may be controlled to run in a mode dedicated for a lowest user access right of the two or more users. This embodiment can automatically implement access right management. For example, a visitor or a babysitter may have a lower user access right than a family member. When there are a visitor and a family member in the determined scenario, the family member may want to turn off some intelligent appliances or restrict the visitor to use some intelligent appliances in order to protect the family's privacy. Without the proposed solution, the family member may manually turn off some intelligent appliances or restrict the visitor to use some intelligent appliances, which it is not a convenience way for both the family member and the visitor. With the proposed solution, it can enable the controller to control the at least one device to run in a mode dedicated for a lowest user access right of the two or more users. For example, the at least one device may be automatically controlled by the controller to be turned off or restricted to be used by the visitor.

In an embodiment, controlling the at least one device to run in the mode dedicated for the determined scenario may comprise at least one of controlling a television set to list at least one program that is useful to the at least one user; controlling a device to provide a summary list of the at least one program to the at least one user; controlling a display of a vehicle to display the at least one program; controlling a device to record a video for the at least one user; controlling a device to hide at least one message related to the video; controlling a device to provide a reminder of backup to the at least one user; controlling a device to provide a recommended shopping list to the at least one user; or controlling a device to provide availability information of at least one nearby laundry room to the at least one user.

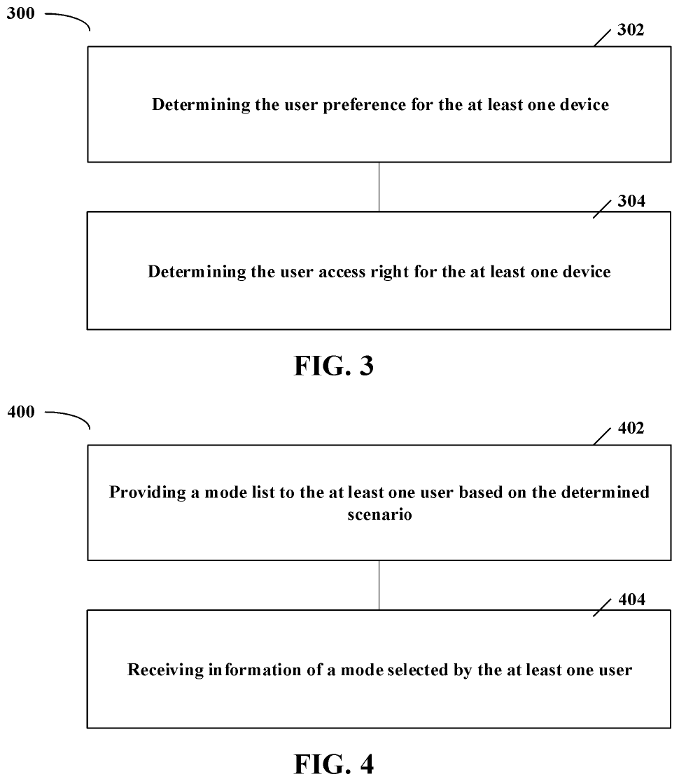

FIG. 3 shows a flowchart of a method 300 according to another embodiment of the present disclosure.

At block 302, the controller may determine the user preference for the at least one device. The controller may determine the user preference for the at least one device in various ways. For example, the controller may determine the user preference for the at least one device based on the data collected at blocks 202 and 204 of FIG. 2. The user preference for the at least one device may be input by the at least one user. The controller may obtain the user preference for the at least one device from another controller. The controller may determine the user preference for the at least one device based on a conversation of the user.

At block 304, the controller may determine the user access right for the at least one device. The controller may determine the user access right for the at least one device in various was. For example, the user access right for the at least one device may be set by a user such as a family member or an owner of the controller. The user access right for the at least one device may be determined by the controller based on user category. The user access right for the at least one device may be determined by the controller based on user's age. The controller may determine the user access right for the at least one device based on a conversation of a user. The controller may obtain the user access right for the at least one device from another controller.

FIG. 4 shows a flowchart of a method 400 according to another embodiment of the present disclosure.

At block 402, the controller may provide a mode list to the at least one user based on the determined scenario. The controller may provide a mode list to the at least one user based on the determined scenario due to various reasons. For example, when there are two or more modes dedicated for the determined scenario, the controller may provide a mode list including the two or more modes to the at least one user. When the determined scenario comprises two or more users and the modes dedicated for different users are conflicted, the controller may provide the mode list including two or more modes to the at least one user.

At block 404, the controller may receive information of a mode selected by the at least one user. For example, the at least one user may select a mode from the mode list and send information of the selected mode to the controller. The controller may send a message for controlling at least one device to run in the selected mode to the at least one device. The controller may store this information and determine the user preference for the at least one device based on the information.

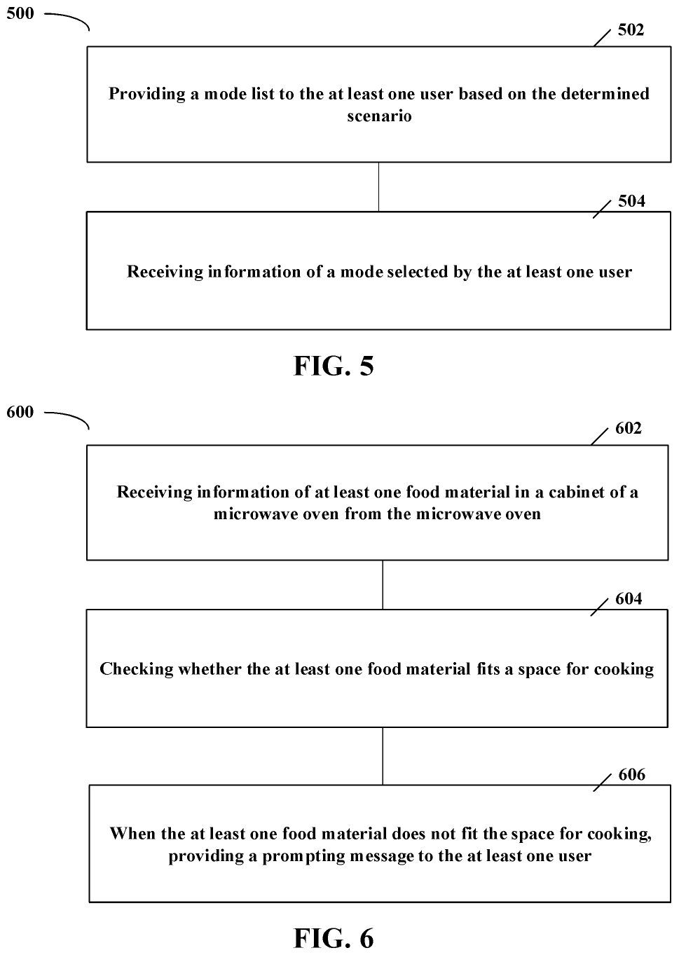

FIG. 5 shows a flowchart of a method 500 according to another embodiment of the present disclosure.

At block 502, the controller may provide information regarding at least one suggested activity to the at least one user based on the determined scenario. During a period that the at least one device is running in the mode dedicated for the determined scenario, the at least one user may do some other activities that can be completed in this period. In this case, the controller may provide information regarding at least one suggested activity to the at least one user based on the determined scenario. For example, supposing that the controller has sent a message to control a microwave oven to cook some food for a user and a cooking period may be 30 minutes, the controller may provide information regarding at least one suggested activity that can be completed in the cooking period. For example, the controller may suggest the user to water his/her plants as he/she enjoys gardening, play with a pet, and/or tell a child a story. The controller may enable a TV set to list a recommendation of programs that match to the user's activities. Without the proposed solution, the user may browse and select the program manually, several minutes may be spent, which may make the user a bit crazy.

At block 504, the controller may receive a feedback regarding whether the at least one suggested activity is appropriate from the at least one user. The controller may store this information and determine the user's habit and/or preference and/or interest based on the feedback.

FIG. 6 shows a flowchart of a method 600 according to another embodiment of the present disclosure.

At block 602, the controller may receive information of at least one food material in a cabinet of a microwave oven from the microwave oven. The information of at least one food material may be an three dimension image of the at least one food material or any other suitable information. Based on the information of at least one food material, the controller may determine the size and/or type of at least one food material.

At block 604, the controller may check whether the at least one food material fits a space for cooking. For example, the controller may store respective size threshold for the at least one food material. The respective size threshold for the at least one food material may be input by a user or a manufacturer of the microwave oven or can be learned by the controller or the microwave oven. The controller may check whether the at least one food material fits a space for cooking based on a comparison of the respective size threshold and respective actual size for the at least one food material.

At block 606, the controller may provide a prompting message to the at least one user when the at least one food material does not fit the space for cooking. The prompting message may be a voice message, a video message, an image message, a text message, a warning signal, etc. The controller may provide the prompting message to its output device which may output it to the at least one user. Alternatively, the controller may provide the prompting message to the microwave oven or another device which may provide the prompting message to the at least one user.

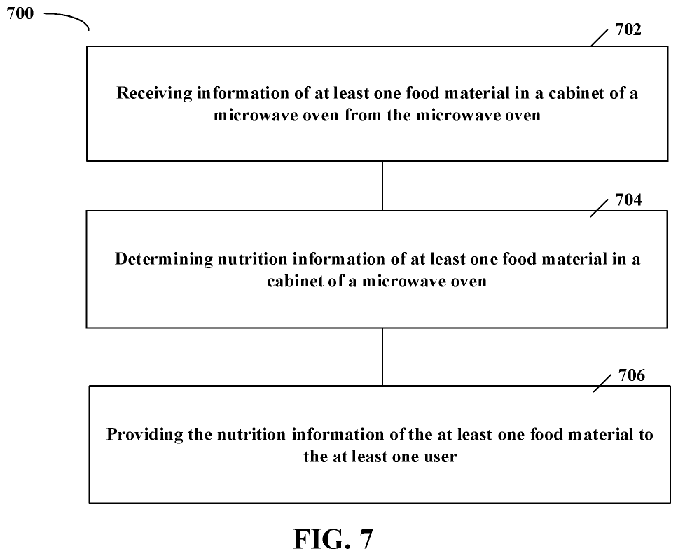

FIG. 7 shows a flowchart of a method 700 according to another embodiment of the present disclosure.

At block 702, the controller may receive information of at least one food material in a cabinet of a microwave oven from the microwave oven. Block 702 is same as block 602 of FIG. 7.

At block 704, the controller may determine nutrition information of at least one food material in the cabinet of the microwave oven. For example, the controller may determine nutrition information of at least one food material in the cabinet of the microwave oven based on the size of the at least one food material.

At block 706, the controller may provide the nutrition information of the at least one food material to the at least one user. The nutrition information may be provided in a voice message, a video message, an image message, a text message, etc. The controller may provide the nutrition information to its output device which may output it to the at least one user. Alternatively, the controller may provide the nutrition information to the microwave oven or another device which may provide the nutrition information to the at least one user.

FIG. 8 shows a flowchart of a method 800 according to another embodiment of the present disclosure.

At block 802, the controller may receive tracking information regarding a twin. The tracking information may be any suitable information regarding the twin. For example, the tracking information may be image information such as behavior information, clothing information, expression information, walking path information, etc. of the twin. The image information can be obtained by at least one camera and sent to the controller.

At block 804, the controller may recognize the twin based on the tracking information.

At block 806, the controller may provide recognition information of the twin to a user. For example, the controller may provide recognition information of the twin to a smart glass of the user which may display the recognition information of the twin to a user.

FIG. 9 shows a flowchart of a method 900 according to another embodiment of the present disclosure, which may be performed by a device. As such, the device may provide means or module for accomplishing various parts of the method 900 as well as means for accomplishing other processes in conjunction with other components. For some parts which have been described in the above embodiments, detailed description thereof is omitted here for brevity.

At block 902, the device may receive a message for controlling the device to run in a mode dedicated for a specific scenario related to at least one user from a controller. For example, the controller may send this message to the device at block 208 of FIG. 2, and then the device may receive this message. For example, the controller may determine the specific scenario related to at least one user as described in block 206 of FIG. 2.

At block 904, the device may run in the mode dedicated for the specific scenario.

In an embodiment, the specific scenario may comprise any information of an identity of the at least one user; a number of the at least one user; an activity of the at least one user; conversation content of the at least one user; a physical state of the at least one user; a psychological state of the at least one user; environmental data related to the at least one user; a habit of the at least one user; an interest of the at least one user; a schedule of the at least one user; an emotion of the at least one user; or an expression of the at least one user.

In an embodiment, the specific scenario may be determined based on any information of an identity of the at least one user; a number of the at least one user; an activity of the at least one user; conversation content of the at least one user; a physical state of the at least one user; a psychological state of the at least one user; environmental data related to the at least one user; a habit of the at least one user; an interest of the at least one user; a schedule of the at least one user; an emotion of the at least one user; or an expression of the at least one user.

In an embodiment, the mode dedicated for the specific scenario may comprise at least one of: a mode dedicated for a user preference for the device; a mode dedicated for a user access right for the device; or a mode selected by the at least one user.

In an embodiment, when there are two or more users in the specific scenario, the device is controlled to run in a mode dedicated for a lowest user access right of the two or more users.

In an embodiment, controlling the device to run in the mode dedicated for the specific scenario may comprise at least one of controlling a television set to list at least one program that is useful to the at least one user; controlling a device to provide a summary list of the at least one program to the at least one user; controlling a display of a vehicle to display the at least one program; controlling a device to record a video for the at least one user; controlling a device to hide at least one message related to the video; controlling a device to provide a reminder of backup to the at least one user; controlling a device to provide a recommended shopping list to the at least one user; or controlling a device to provide availability information of at least one nearby laundry room to the at least one user.

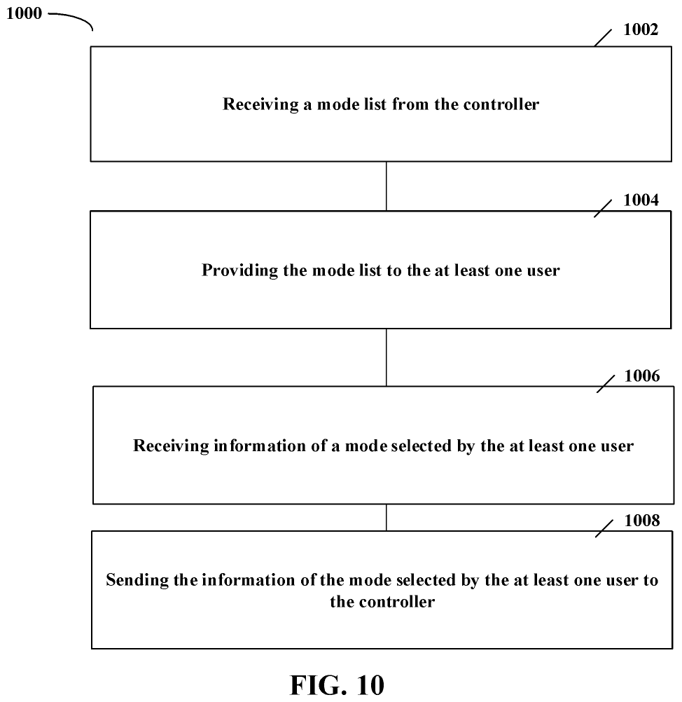

FIG. 10 shows a flowchart of a method 1000 according to another embodiment of the present disclosure. For some parts which have been described in the above embodiments, detailed description thereof is omitted here for brevity.

At block 1002, the device may receive a mode list from the controller. For example, the controller may send the mode list to the device at block 402 of FIG. 4, and then the device may receive the mode list.

At block 1004, the device may provide the mode list to the at least one user. For example, the mode list may be provided to the at least one user in a voice message, a video message, an image message, etc.

At block 1006, the device may receive information of a mode selected by the at least one user. For example, the at least one used may select one mode by using various input methods such as voice, mouse, gesture, touch, etc.

At block 1008, the device may send the information of the mode selected by the at least one user to the controller.

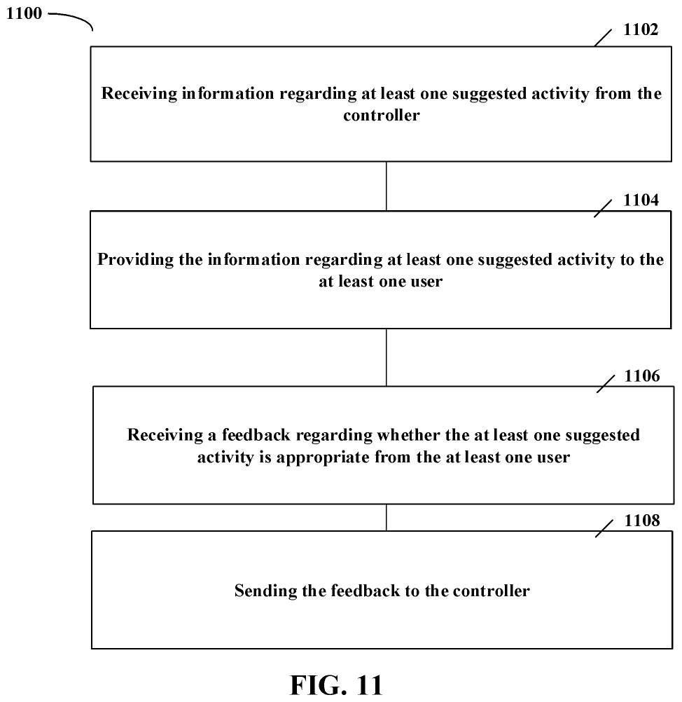

FIG. 11 shows a flowchart of a method 1100 according to another embodiment of the present disclosure. For some parts which have been described in the above embodiments, detailed description thereof is omitted here for brevity.

At block 1102, the device may receive information regarding at least one suggested activity from the controller. For example, the controller may provide the information regarding at least one suggested activity to the device at block 502 of FIG. 5, and then the device may receive the information regarding the at least one suggested activity.

At block 1104, the device may provide the information regarding at least one suggested activity to the at least one user. For example, the information regarding the at least one suggested activity may be provided to the at least one user in a voice message, a video message, an image message, etc.

At block 1106, the device may receive a feedback regarding whether the at least one suggested activity is appropriate from the at least one user. For example, the feedback may indicate that the at least one suggested activity is appropriate. The feedback may indicate that the at least one suggested activity is not appropriate. The feedback may indicate that at least one specific activity that the at least one user is about to do.

At block 1108, the device may send the feedback to the controller.

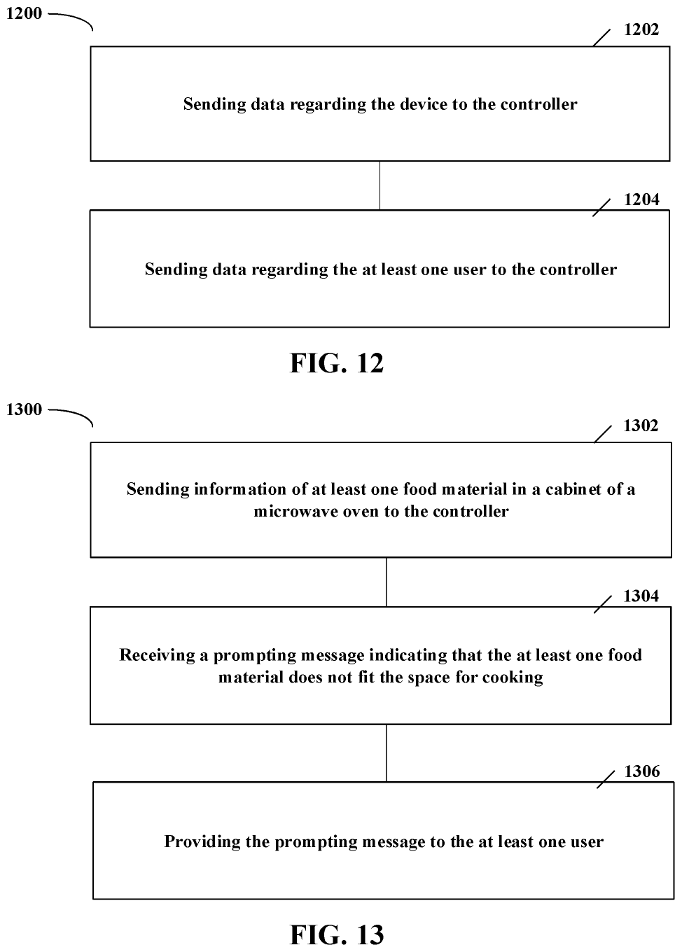

FIG. 12 shows a flowchart of a method 1200 according to another embodiment of the present disclosure. For some parts which have been described in the above embodiments, detailed description thereof is omitted here for brevity.

At block 1202, the device may send data regarding the device to the controller.

At block 1204, the device may send data regarding the at least one user to the controller.

FIG. 13 shows a flowchart of a method 1300 according to another embodiment of the present disclosure. For some parts which have been described in the above embodiments, detailed description thereof is omitted here for brevity.

At block 1302, the device may send information of at least one food material in a cabinet of a microwave oven to the controller.

At block 1304, the device may receive a prompting message indicating that the at least one food material does not fit the space for cooking.

At block 1306, the device may provide the prompting message to the at least one user. For example, the prompting message may be provided to the at least one user in a voice message, a video message, an image message, etc.

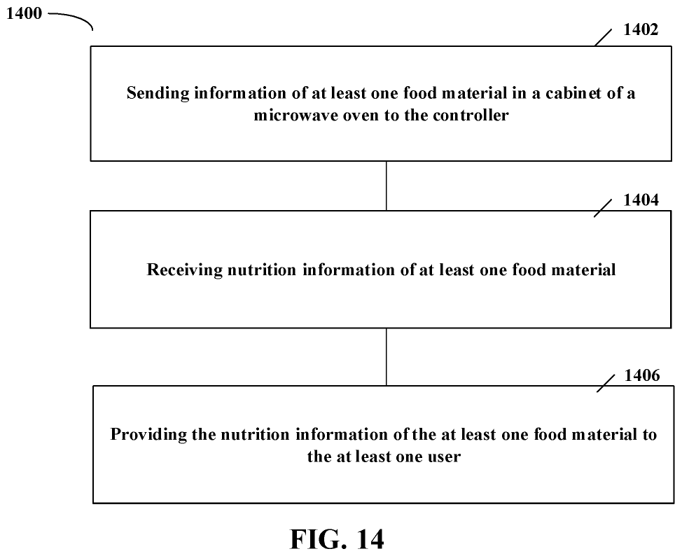

FIG. 14 shows a flowchart of a method 1400 according to another embodiment of the present disclosure. For some parts which have been described in the above embodiments, detailed description thereof is omitted here for brevity.

At block 1402, the device may send information of at least one food material in a cabinet of a microwave oven to the controller.

At block 1404, the device may receive nutrition information of at least one food material; and

At block 1406, the device may provide the nutrition information of the at least one food material to the at least one user. For example, the nutrition information may be provided to the at least one user in a voice message, a video message, an image message, etc.

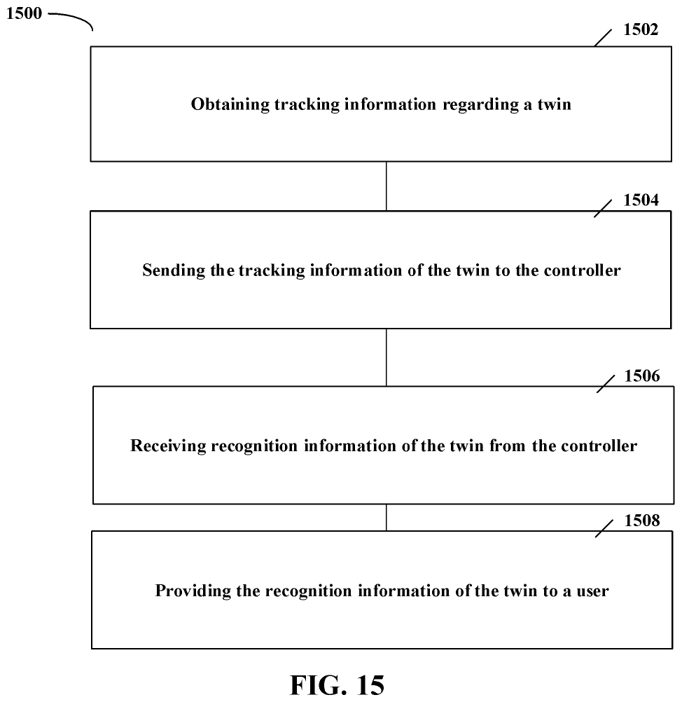

FIG. 15 shows a flowchart of a method 1500 according to another embodiment of the present disclosure. For some parts which have been described in the above embodiments, detailed description thereof is omitted here for brevity.

At block 1502, the device may obtain tracking information regarding a twin.

At block 1504, the device may send the tracking information of the twin to the controller.

At block 1506, the device may receive recognition information of the twin from the controller.

At block 1508, the device may provide the recognition information of the twin to a user. For example, the recognition information may be provided to the user in a voice message, a video message, an image message, etc.

In some embodiments, the proposed solution may integrate various kinds of intelligent household appliances via a centralized platform (i.e., the controller). The centralized platform may store data (such as preference and dislike) regarding at least one user such as family member. The data regarding at least one user may be iteratively collected from the habits and manners of the at least one user. In addition, the data regarding at least one user may be manually input into the centralized platform.

In an embodiment, when there is only one user such as family member that is about to use at least one device, the centralized platform or the controller may determine an identity of the user by recognizing the user's face or specified body gesture. Then the centralized platform or the controller may send a message for controlling the at least one device to run in a mode dedicated for the identity of the user to the at least one device. In this way, the at least one device may run in a mode that dedicated for the user such as family member without manually switching or changing the mode of the at least one device.

In an embodiment, when there are multiple users such as family members that are about to use the at least one device, the centralized platform or the controller may recognize the content that they are talking and determine a scenario related to at least one user based on the recognized content. If there are two or more modes dedicated for the specific scenario and these modes have a conflict, the centralized platform or the controller may provide a mode list for a user to select.

In an embodiment, when there is no family member that is about to use the at least one device and there is only a visitor or a babysitter is about to use the at least one device, the centralized platform or the controller may cause sensitive or privacy information to be not shared to the visitor or the babysitter. For example, some devices may be powered off or can not be used by the visitor or the babysitter. A part of information of a device can be shared to the visitor or the babysitter.

In an embodiment, the controller may detect which user is currently using or to use a device. The controller may request the device to bring a best user experience for this user for example based on the user's current status. The controller may also request any other device to cooperate together so that the user may enjoy a best experience provided by these devices. For example, when a user is watching a talk show program, the user may need some environmental stimuli to make the user happy. Thus, the controller may send a message to a smart curtain to let the smart curtain open a curtain to let more sunshine into the user's home, so long as a brightness in the user's home won't interfere the talk show program which is shown on a TV screen. As another example, when a user is watching a horrible movie, the controller may send a message to the smart curtain to let the smart curtain close the curtain to create a better atmosphere.

There has been too many cases that family members may quarrel with each other on the user of at least one device, or they may turn to their own small world and use their respective devices, which is not a good way to build a more strong family relationship. In an embodiment, when there are multiple users who are about to use at least one device or to be served by the at least one device, the controller may recognize content that they are talking about, try to make a suggested running mode of the at least one device and provide the suggested running mode to at least one user. If the at least one user provides a feedback indicating that they do not accept the suggested running mode, the controller may provide a mode list based on all users' preference and request at least one user to select a mode from the mode list. This embodiment may bring a fun instead of a conflict or an isolation.

Different users such as visitors and babysitters may be properly treated in a better way. In an embodiment, the controller may send a message for controlling at least one device to run in a mode dedicated for a user. For example, the controller may send a message for controlling a device to be turned off such that the visitors and babysitters may not use this device. This embodiment may recognize an identity of the at least one user and control at least one device to run in a mode dedicated for the identity of the at least one user to protect the privacy information.

In an embodiment, the controller may manage at least one device such as intelligent house appliance and may store the following data: a playlist from an audio device, a program list from a TV set, air conditioner settings, refrigerator contents and settings, microwave oven settings, curtain status, air temperature, air humidity, a shower temperature, etc.

The controller may capture, store and then analyze the following data:
Conversation among at least one user such as family member and an abstract of conversation content.
At least one activity of at least one user, such as a kinetic game, a housekeeping task, a cooking task, a gardening task or a babysitting task, etc.
a physical status of at least one user, including face status, hair status, body shape, etc.
environmental data such as climate, weather, indoor environmental data, etc.
a habit, an interest, a schedule, etc. of at least one user.

Based on the data stored by the controller, the controller is able to provide at least one suggested activity to the at least one user and control at least one device (such as intelligent appliances) to run in a mode dedicated for a specific scenario. Also, the at least one user can provide a feedback on whether the at least one suggested activity and/or mode is appropriate.

Moreover, the device may comprise any suitable device such as a car and a device used in a private space, or a device used in a space dedicated for a user (such as a business class in the airplane or high-speed train). In an embodiment, if a passenger flow in a space (e.g., subway, bus, train, etc.) is lower than a threshold, an advertisement display screen (such as LCD (liquid crystal display)/LED (Light Emitting Diode)) may provide dedicated information for at least one user. For example, the information of the advertisement display screen can be specialized for at least one user.

In an embodiment, the controller may determine twins' identities in the following ways so that the twins can enjoy their customized intelligent devices or services:
Tracking the twins' entire routine at home for example starting from getting up to any home activities.
Tracking the twins' work schedules in a company till all home activities.

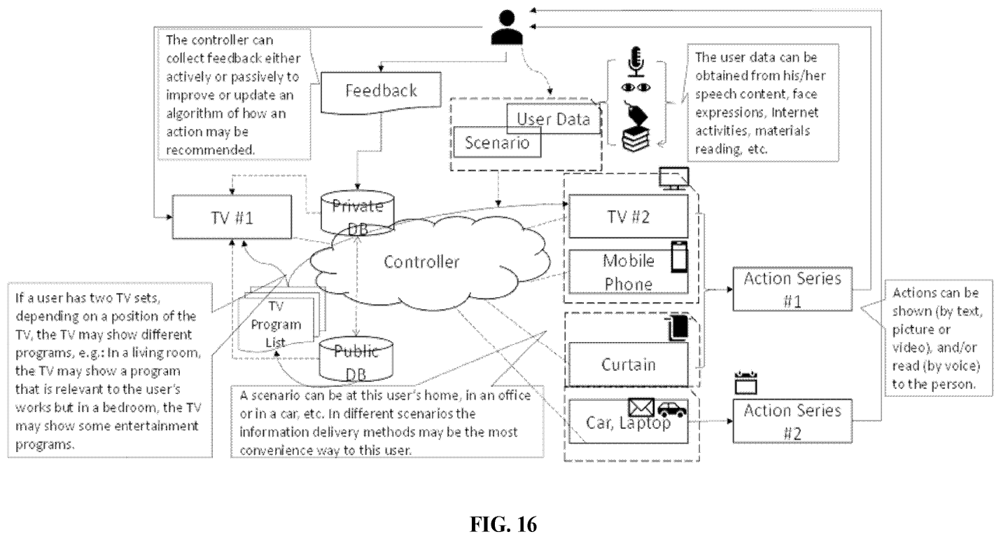

FIG. 16 shows an example of TV program selection according to an embodiment of the present disclosure. For some parts which have been described in the above embodiments, detailed description thereof is omitted here for brevity. The example of TV program selection illustrates how to bring more convenience to a user.

Usually, an intelligent TV may only provide a limited “intelligence”. For example, the TV can install some applications for example from Internet. The TV may be manipulated by voice. The TV may be connected to other appliances and then operate them. These features may be far away from “intelligent”.

In this embodiment, the controller may take at least one initiative action to give at least one user at least one suggestion on which program the at least one user would like to watch. For example, the controller may enable a microphone to capture a user's conversation with other family members, a phone call with a colleague and/or a friend, etc. The controller may capture at least one instant message and/or at least one activity that the user has done in recent couple of days. An example of how the controller to recommend a TV program to a user is as following. Assuming the user is going to write a business analysis report to his/her company in IoT development area. However, the scope of the IoT development area is too large to find out some specialized TV program for his/her inspiration. Thus, the following actions may be done by the user and can be discovered by the controller:
the user's expression is showing anxiety when the user is changing the TV channels
the user's keywords in Internet searching and page views may be highly relevant to IoT and its derivative areas
the user might have borrowed some books from a library in the IoT development area
the user's conversations may have discussions, talks and complains in this activity (e.g., writing a business analysis report”).

After collecting the above information, the controller can use the TV set to list at least one program that may have inspirations or be useful to the user in a splash screen of the TV set. This can make much convenience to the user as it can avoid too many TV channel selections. And, the controller can provide a summary list of at least one relevant program via an email to the user's mailbox for example when the user is in working hour, or an SMS message for example when the user is taking bus/subway, or show it on a HUD (Head Up Display) for example when the user is driving a car. The controller can also chose which media is the best place to show such information if there are multiple choices. For example, the summary list can be sent via an email or displayed via HUD in a car. If the user is driving a car, then the user is preferred to briefly read in on the HUD. The user is preferred to read it thoroughly via an email when the user has arrived at the office.

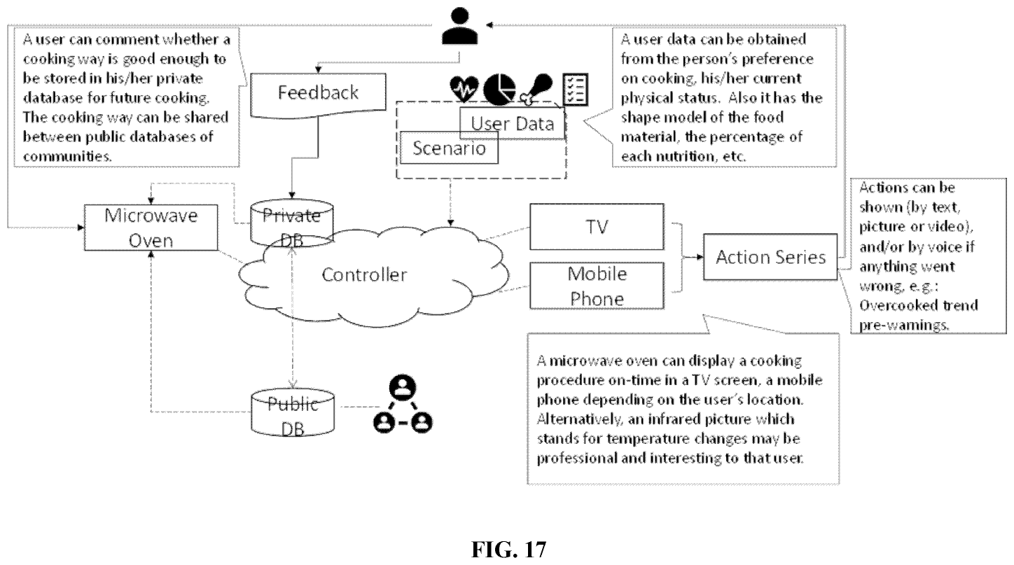

FIG. 17 shows an example of microwave oven cooking program setting according to an embodiment of the present disclosure. For some parts which have been described in the above embodiments, detailed description thereof is omitted here for brevity. The example of microwave oven cooking program setting illustrates how an intelligent microwave oven can help a user to cook more professionally.

Before any cooking, the controller may check whether at least one food material in a cabinet of the microwave oven fits a space for cooking.

For example, a camera installed in the cabinet of the microwave oven may obtain the shape of the food material and send this information to the controller. If the food material is too big or small or a rather irregular one, the controller may prompt the user to take some actions before cooking; or remind the user that it might not be able to cook in a best practice. In an embodiment, the controller may determine a percentage of each nutrition such as protein, carbohydrate and fat. The controller may can provide information of the percentage of each nutrition to the user for a reference.

The controller may check the user's preference as well as the user's historical cooking records with similar food materials. The controller may cause the microwave oven to show cooking time information (such as light distribution) on the microwave oven's door or transfer the cooking time information to a TV screen if the cooking time is long and the user is leaving a kitchen to do other things. This may be a very useful feature when the user is taking a bus or subway train where it's hard to do other activities but it may be fine to do some cooking tweaks and then enjoy the cooked food right after back to home.

For example, the cooking period may be in a span of 5 to 30 minutes, and the user might do some other activities that can be completed during this cooking period. For example, the user may water his/her plants, play with a pet and tell a child a story. Thus, the TV set may list a recommendation of programs that match to these activities. Otherwise, the user must browser or select the program manually and several minutes may be spent, which may make the user a bit crazy. When the cooking is almost finished, the user has to back to the kitchen.

If two or more users are to use a similar pattern to cook a certain food material(s), then it might be the best way to set the similar pattern as a reference (best practice) for a new user who buys the microwave oven.

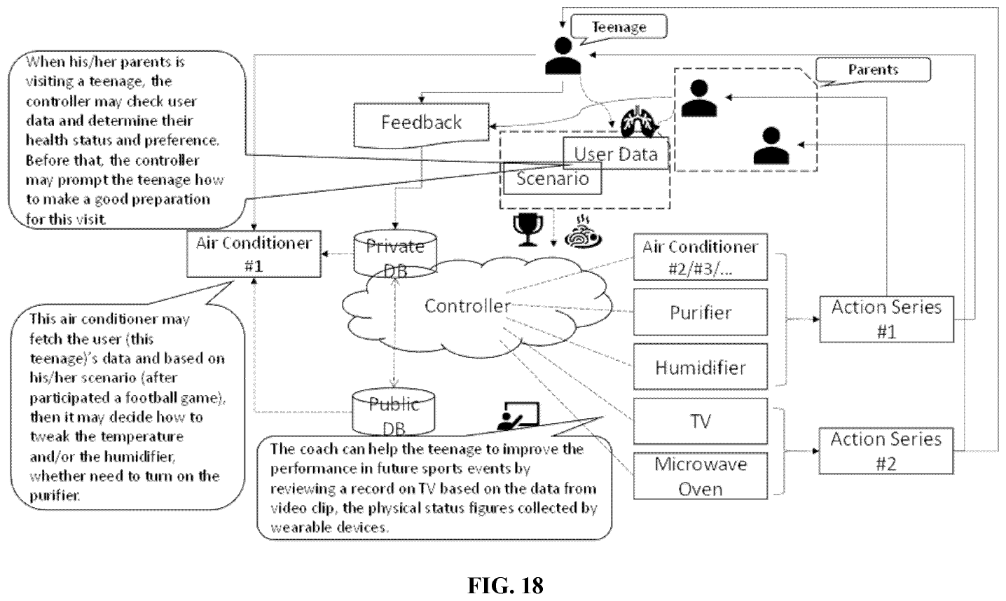

FIG. 18 shows an example of air conditioner temperature settings, purifier settings and humidifier settings according to an embodiment of the present disclosure. For some parts which have been described in the above embodiments, detailed description thereof is omitted here for brevity. The example of air conditioner temperature setting, purifier setting and humidifier setting illustrates how two or more devices can work together for a user or all family members.

Currently, an air conditioner, a purifier and a humidifier may work separately, even some air conditioners are combined with purifiers, the settings of air conditioners are not intelligent at all to a specified user, let alone to all family members.

In this embodiment, the controller may control the above devices and adjust them to run in a special pattern that fit for at least one user. For example, if a user is a teenage who likes sports activities, the user may feel hot when the user arrives home after a sport event such as a football game, but it's not good to set the temperature of the air conditioner too low as it might lead to cough afterwards. In this scenario, the controller may set a temperature of the air conditioner a bit higher than a temperature usually set by the user, turn on a ventilation system (rather than the purifier) and lower a humidity of the user's room for best feeling. While the user is at rest, a bracelet may detect that the user's heartbeat is lower than a threshold and then the temperature of the air conditioner can be set as the temperature usually set by the user. Also, the user may feel rather tired as detected by a camera installed in front of a TV set, then it's a good time to review his/her performance in a sport event. The user's mobile phone may prompt an option message regarding whether the user likes to review camera records as well as data collected by the bracelet. If the user would like to review it, a coach of the user may also be invited to give some suggestions or ideas to improve the user's sports performance.

After a moment, the user's parents are going to visit the user. They are elder people and may have some pollen allergy as checked from their medical records. Thus, the controller may prompt the user to turn on the purifier before the user's parents come to the user's apartment.

Now there are three persons in an apartment, the controller may control at least one device to change its working mode to balance everyone's feeling. For example, based on a visit frequency of the parents, the controller may determine that they may visit their child in a pattern such as after the user has participated in a sports event, so there may be some activities to be held, such as recapping their child's sports event and celebrating. Then the controller may inform the user in advance to buy some foods and drinks as a preparation for a parents visit. If the user can make a splendid meal for the parents, it would be excellent. The example of microwave oven cooking program setting as shown in FIG. 17 can be used in this scenario.

The controller may detect there are several people in a living room, then the controller may control the air conditioner to low down the temperature and turn on the purifier for the elder people, and turn off the humidifier. When these people are in separated rooms, such as their bedrooms, the controller may control the air conditioner to do ventilation in the living room and separately set the temperature and humidity for persons in each bedroom.

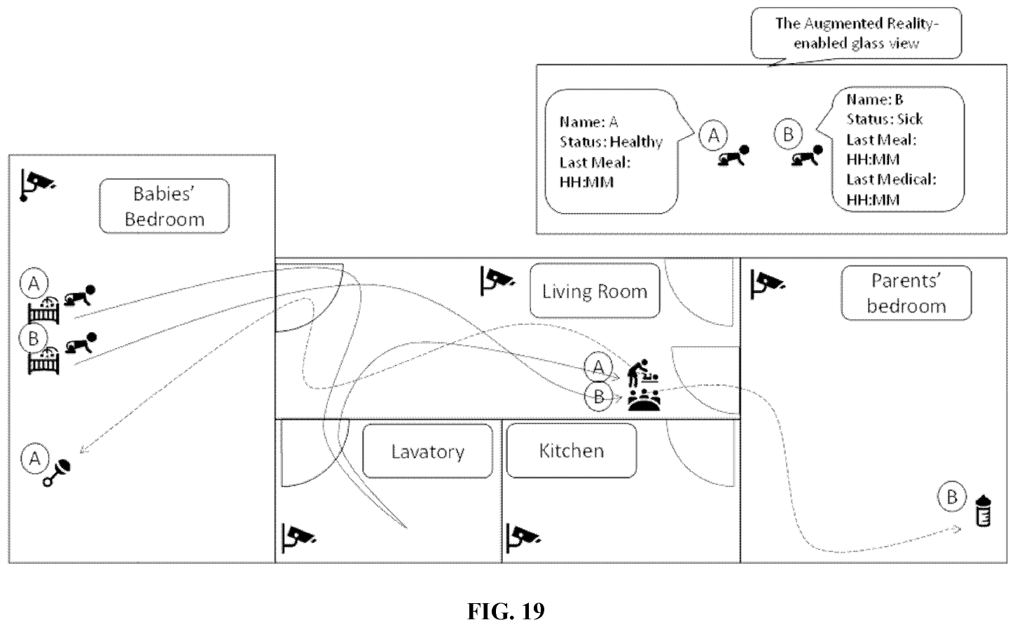

FIG. 19 shows an example of twin children babysitting according to an embodiment of the present disclosure. For some parts which have been described in the above embodiments, detailed description thereof is omitted here for brevity. The example of twin children babysitting illustrates how a babysitter to take care of twins.

Twins' face recognition may be a difficult problem. In this embodiment, the controller may use another way to distinguish twins. Each twin may have his/her own bed which may not be changed in normal scenarios. By utilizing at least one camera installed in home, the controller can track each twin's activities and walking paths and then recognize each twin based on the activities and walking paths. The controller can control a smart glass (with a HUD feature) that is worn by a babysitter to mark each twin. Therefore in some situations, e.g., one of twins has fallen sick, the babysitter may not give a medicine to a wrong baby.

The controller can also discover the twins' minor different behavior and then the parents can give the twins more specified coach during their growth. Also, a TV set can display the twins' growth data such as height, weight, head circumference and other criteria in at least one reference figure.

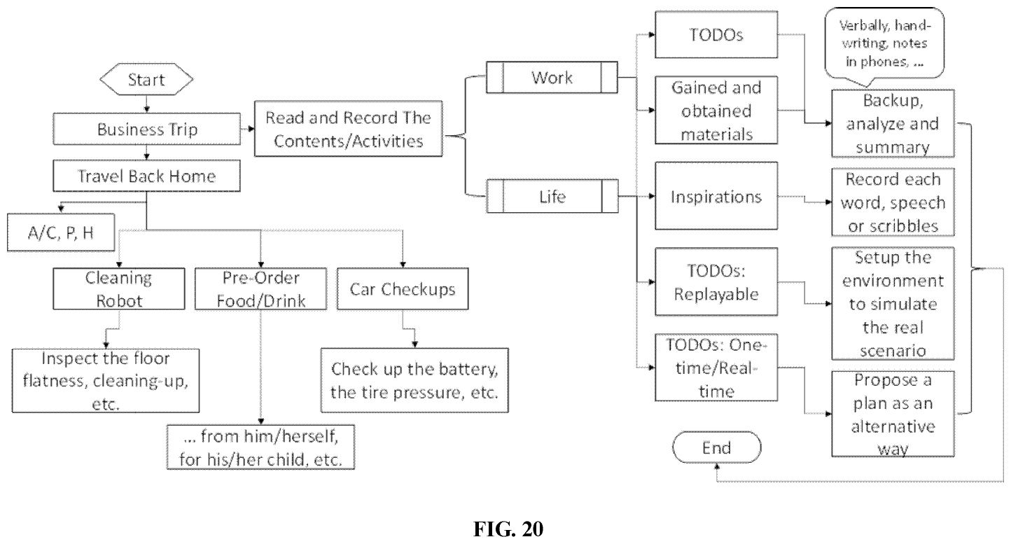

FIG. 20 shows an example of businessman assistant after back home according to an embodiment of the present disclosure. For some parts which have been described in the above embodiments, detailed description thereof is omitted here for brevity.

It may be a normal requirement that every person wants to have a good rest and relax after his/her business journey. However, the existing intelligent device controlling solution is still far away from “intelligent”, but they are just “remote control”.

Usually, when a businessman is backing home from an airport or a railway station, he/she may turn on an air-conditioner, a purifier and a humidifier on the way so that he/she can enjoy a good atmosphere soon after arriving home. In this embodiment, the controller may check the businessman's interests and hobbies. For example, the businessman likes football games. However during his/her journey, an important game is missed, and then the controller may control a TV set to record an entire game for the businessman. Moreover, the controller may control at least one terminal device (such as a mobile phone, a pad or a laptop) of the businessman to hide at least one relevant new of this game before the recorded game is fully played by the businessman. In this way, the businessman may enjoy the best experience when the businessman watches the recorded game.

When the businessman arrives home to watch the TV or have dinner, in the meanwhile, a prioritized task may be to backup his/her data obtained during this business journey, as the businessman may have stored it in a laptop or a portable storage media which is not so secure, the controller may prompt this user on a TV screen with a backup reminder, for example inserting the portable storage media to a USB (Universal Serial Bus) port of a backup device or connecting the laptop to network for backup.

In an embodiment, the controller may provide a recommended shopping list for example for food to a user.

In an embodiment, the controller may check availability of at least one nearby laundry room and provide the availability information of the at least one nearby laundry room to a user.

In an embodiment, the controller may control at least one intelligent household appliance to provide at least one service specified for different scenarios. The controller may provide its service in various scenarios, e.g., in home, in a person's travelling (such as the user is driving, or taking a bus or train), and in office time. The proposed solution can support various user activities to reduce the user's time overhead.

In an embodiment, the controller may observe user's offline activities such as gardening, sports events participation, conversations between family members, business partners and colleagues, and then automatically backup, analyze and summary the activities and help the user to plan next activities (TODOs). The controller can act as a bridge between the real world and the cyberspace. The user is able to give a feedback to make the controller to make a more suitable work for the user.

In an embodiment, the controller may handle a complex situation that there are multiple people to use at least one device or to be served by at least one device in a same time. The controller may provide various suggestions for user selection. In an embodiment, the controller may control at least one device to hide privacy information when there is a visitor or babysitter.

In an embodiment, the controller may act as an information sharing hub of a community, no matter in the real world or cyberspace. The controller can enable a user to easily exchange information or ideas when the controller is connected to Internet. In this way, the user may exchange and share information and be motivated with each other.

Various embodiments herein offer various advantages, of which a non-exhaustive list of examples follows. In some embodiments herein, the proposed solution may enable a controller to control at least one device to run in a mode dedicated for a specific scenario. In some embodiments herein, the proposed solution may bring a good user experience to a user. In some embodiments herein, the proposed solution may enable two or more devices to cooperate together so that the user may enjoy convenience. In some embodiments herein, the proposed solution may protect private information. The embodiments herein are not limited to the features and advantages mentioned above. A person skilled in the art will recognize additional features and advantages upon reading the detailed description.

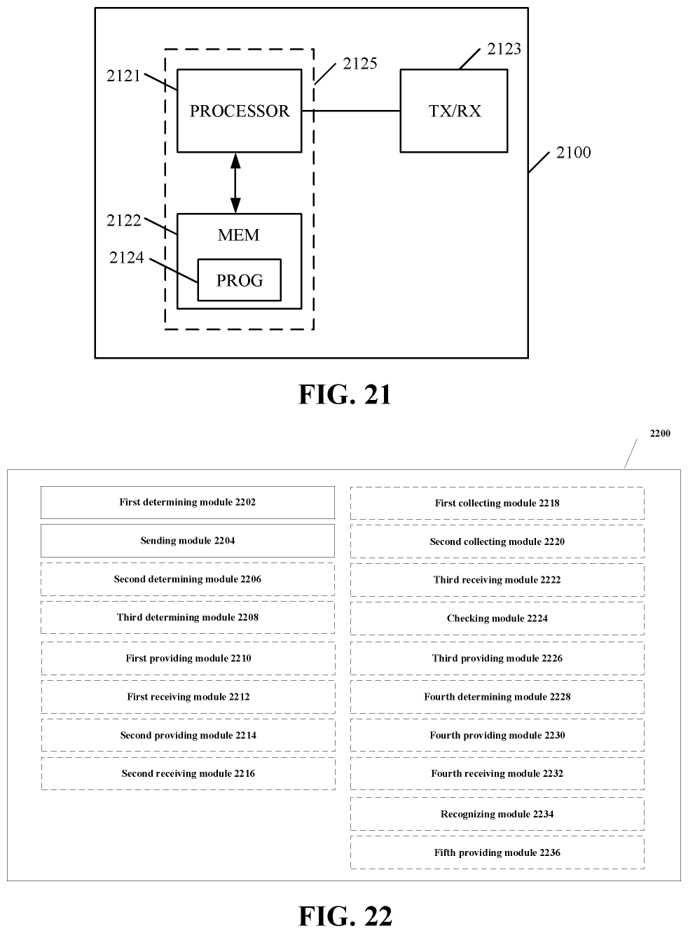

FIG. 21 is a block diagram showing an apparatus suitable for practicing some embodiments of the disclosure. For example, any one of the controller and the device as described above may be implemented as or through the apparatus 2100.

The apparatus 2100 comprises at least one processor 2121, such as a DP (digital processor), and at least one MEM (memory) 2122 coupled to the processor 2121. The apparatus 2120 may further comprise a transmitter (TX) and receiver (RX) 2123 coupled to the processor 2121. The MEM 2122 stores a PROG (program) 2124. The PROG 2124 may include instructions that, when executed on the associated processor 2121, enable the apparatus 2120 to operate in accordance with the embodiments of the present disclosure. A combination of the at least one processor 2121 and the at least one MEM 2122 may form processing means 2125 adapted to implement various embodiments of the present disclosure.

Various embodiments of the present disclosure may be implemented by computer program executable by one or more of the processor 2121, software, firmware, hardware or in a combination thereof.

The MEM 2122 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 2121 may be of any type suitable to the local technical environment, and may include one or more of general purpose computers, special purpose computers, microprocessors, digital signal processors DSPs (digital signal processors) and processors based on multicore processor architecture, as non-limiting examples.

In an embodiment where the apparatus is implemented as or at the controller, the memory 2122 contains instructions executable by the processor 2121, whereby the controller operates according to any of the methods related to the controller as described above.

In an embodiment where the apparatus is implemented as or at the device, the memory 2122 contains instructions executable by the processor 2121, whereby the device operates according to any of the methods related to the device as described above.

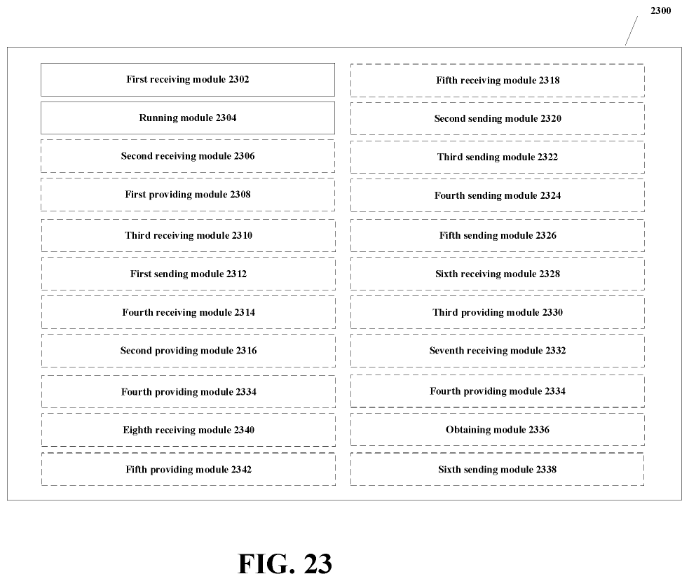

FIG. 22 is a block diagram showing a controller according to an embodiment of the disclosure. As shown, the controller 2200 comprises a first determining module 2202 and a sending module 2204. The determining module 2202 may be configured to determine a scenario related to at least one user. The sending module 2204 may be configured to send a message for controlling at least one device to run in a mode dedicated for the determined scenario to the at least one device.

In an embodiment, the controller 2200 may further comprise a second determining module 2206 configured to determine the user preference for the at least one device.

In an embodiment, the controller 2200 may further comprise a third determining module 2208 configured to determine the user access right for the at least one device.

In an embodiment, the controller 2200 may further comprise a first providing module 2210 configured to provide a mode list to the at least one user based on the determined scenario.

In an embodiment, the controller 2200 may further comprise a first receiving module 2212 configured to receive information of a mode selected by the at least one user.

In an embodiment, the controller 2200 may further comprise a second providing module 2214 configured to provide information regarding at least one suggested activity to the at least one user based on the specific scenario.

In an embodiment, the controller 2200 may further comprise a second receiving module 2216 configured to receive a feedback regarding whether the at least one suggested activity is appropriate from the at least one user.

In an embodiment, the controller 2200 may further comprise a first collecting module 2218 configured to collect data regarding the at least one device.

In an embodiment, the controller 2200 may further comprise a second collecting module 2220 configured to collect data regarding the at least one user.

In an embodiment, the controller 2200 may further comprise a third receiving module 2222 configured to receive information of at least one food material in a cabinet of a microwave oven from the microwave oven.

In an embodiment, the controller 2200 may further comprise a checking module 2224 configured to check whether the at least one food material fits a space for cooking.

In an embodiment, the controller 2200 may further comprise a third providing module 2226 configured to, when the at least one food material does not fit the space for cooking, provide a prompting message to the at least one user.

In an embodiment, the controller 2200 may further comprise a fourth determining module 2228 configured to determine nutrition information of at least one food material in a cabinet of a microwave oven.

In an embodiment, the controller 2200 may further comprise a fourth providing module 2230 configured to provide the nutrition information of the at least one food material to the at least one user.

In an embodiment, the controller 2200 may further comprise a fourth receiving module 2232 configured to receive tracking information regarding a twin.

In an embodiment, the controller 2200 may further comprise a recognizing module 2234 configured to recognize the twin based on the tracking information.

In an embodiment, the controller 2200 may further comprise a fifth providing module 2236 configured to providing recognition information of the twin to a user.

FIG. 23 is a block diagram showing a device according to an embodiment of the disclosure. As shown, the device 2300 comprises a first receiving module 2302 and a running module 2304. The first receiving module 2302 may be configured to receive a message for controlling the device to run in a mode dedicated for a specific scenario related to at least one user from a controller. The running module 2304 may be configured to run in the mode dedicated for the specific scenario.

In an embodiment, the device 2300 may further comprise a second receiving module 2306 configured to receive a mode list from the controller. The device 2300 may further comprise a first providing module 2308 configured to provide the mode list to the at least one user. The device 2300 may further comprise a third receiving module 2310 configured to receive information of a mode selected by the at least one user. The device 2300 may further comprise a first sending module 2312 configured to send the information of the mode selected by the at least one user to the controller.

In an embodiment, the device 2300 may further comprise a fourth receiving module 2314 configured to receive information regarding at least one suggested activity from the controller. The device 2300 may further comprise a second providing module 2316 configured to provide the information regarding at least one suggested activity to the at least one user.

In an embodiment, the device 2300 may further comprise a fifth receiving module 2318 configured to receive a feedback regarding whether the at least one suggested activity is appropriate from the at least one user. The device 2300 may further comprise a second sending module 2320 configured to send the feedback to the controller.

In an embodiment, the device 2300 may further comprise a third sending module 2322 configured to send data regarding the device to the controller. The device 2300 may further comprise a fourth sending module 2324 configured to send data regarding the at least one user to the controller.

In an embodiment, the device 2300 may further comprise a fifth sending module 2326 configured to send information of at least one food material in a cabinet of a microwave oven to the controller. The device 2300 may further comprise a sixth receiving module 2328 configured to receive a prompting message indicating that the at least one food material does not fit the space for cooking. The device 2300 may further comprise a third providing module 2330 configured to provide the prompting message to the at least one user.

In an embodiment, the device 2300 may further comprise a seventh receiving module 2332 configured to receive nutrition information of at least one food material. The device 2300 may further comprise a fourth providing module 2334 configured to provide the nutrition information of the at least one food material to the at least one user.

In an embodiment, the device 2300 may further comprise an obtaining module 2336 configured to obtain tracking information regarding a twin. The device 2300 may further comprise a sixth sending module 2338 configured to send the tracking information of the twin to the controller.

In an embodiment, the device 2300 may further comprise an eighth receiving module 2340 configured to receive recognition information of the twin from the controller. The device 2300 may further comprise a fifth providing module 2342 configured to provide the recognition information of the twin to a user.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, any of the controller and the device may not need a fixed processor or memory, any computing resource and storage resource may be arranged from any of the controller and the device. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods related to the controller and the device as described above.

According to an aspect of the disclosure it is provided a computer-readable storage medium storing instructions which when executed by at least one processor, cause the at least one processor to carry out any of the methods related to the controller and the device as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-45. (canceled)

46. A method performed by a controller, comprising:
determining a scenario related to at least one user; and
sending a message for controlling at least one device to run in a mode dedicated for the determined scenario to the at least one device.

47. The method according to claim 46, wherein the scenario related to the at least one user comprises any information of:
an identity of the at least one user;
a number of the at least one user;
an activity of the at least one user;
conversation content of the at least one user;
a physical state of the at least one user;
a psychological state of the at least one user;
environmental data related to the at least one user;
a habit of the at least one user;
an interest of the at least one user;
a schedule of the at least one user;
an emotion of the at least one user; or
an expression of the at least one user.

48. The method according to claim 47, wherein the environmental data related to the at least one user comprises at least one of:
climate data;
weather data;
time data;
location data;
traffic condition data; or
passenger flow data.

49. The method according to claim 46, wherein the mode dedicated for the determined scenario comprises at least one of:
a mode dedicated for a user preference for the at least one device;
a mode dedicated for a user access right for the at least one device; or
a mode selected by the at least one user.

50. The method according to claim 49, further comprising:
determining the user preference for the at least one device.

51. The method according to claim 49, further comprising:
determining the user access right for the at least one device.

52. The method according to claim 49, wherein when there are two or more users in the determined scenario, the at least one device is controlled to run in a mode dedicated for a lowest user access right of the two or more users.

53. The method according to claim 46, further comprising:
providing a mode list to the at least one user based on the determined scenario; and
receiving information of a mode selected by the at least one user.

54. The method according to claim 46, further comprising:
providing information regarding at least one suggested activity to the at least one user based on the determined scenario.

55. The method according to claim 54, further comprising:
receiving a feedback regarding whether the at least one suggested activity is appropriate from the at least one user.

56. The method according to claim 46, further comprising:
collecting data regarding the at least one device; and/or
collecting data regarding the at least one user.

57. The method according to claim 56, wherein the data regarding the at least one device comprises settings and/or status information of the at least one device.

58. The method according to claim 56, wherein the data regarding the at least one user comprises the at least one of:
an activity of the at least one user;
conversation content of the at least one user;
a physical state of the at least one user;
a psychological state of the at least one user;
environmental data related to the at least one user;
a habit of the at least one user;
an interest of the at least one user;
a schedule of the at least one user;
an emotion of the at least one user; or
an expression of the at least one user.

59. The method according to claim 46, wherein the at least one user comprises at least one of:
a family member,
a visitor,
a babysitter,
a stranger,
a colleague,
a friend,
a neighbor,
a passenger,
a worker, or
a driver.

60. The method according to claim 46, wherein the at least one device comprises at least one of:
a household appliance;
a car appliance;
a municipal infrastructure;
an industrial electrical equipment;
a computer;
a mobile phone; or
an office appliance.

61. The method according to claim 46, wherein controlling the at least one device to run in the mode dedicated for the determined scenario comprises at least one of:
controlling a television set to list at least one program that is useful to the at least one user;
controlling a device to provide a summary list of the at least one program to the at least one user;
controlling a display of a vehicle to display the at least one program;
controlling a device to record a video for the at least one user;
controlling a device to hide at least one message related to the video;
controlling a device to provide a reminder of backup to the at least one user;
controlling a device to provide a recommended shopping list to the at least one user; or
controlling a device to provide availability information of at least one nearby laundry room to the at least one user.

62. The method according to claim 46, further comprising:
receiving information of at least one food material in a cabinet of a microwave oven from the microwave oven; and
checking whether the at least one food material fits a space for cooking;
when the at least one food material does not fit the space for cooking, providing a prompting message to the at least one user.

63. The method according to claim 46, further comprising:
determining nutrition information of at least one food material in a cabinet of a microwave oven; and
providing the nutrition information of the at least one food material to the at least one user.

64. A method performed by a device, comprising:
receiving a message from a controller, for controlling the device to run in a mode dedicated for a specific scenario related to at least one user; and
running in the mode dedicated for the specific scenario.

65. A controller, comprising:
a processor; and
a memory coupled to the processor, said memory containing instructions executable by said processor, whereby said controller is operative to:
determine a scenario related to at least one user; and
send a message to the at least one device, for controlling at least one device to run in a mode dedicated for the specific scenario.
